(19) United States
(12) Patent Application Publication
(10) Pub. No.: US 2007/0174848 A1
(43) Pub. Date: Jul. 26, 2007

(54) Agentive representation in mobile services

(76) Inventors: Chris Anthony Reed, Dundee (GB); Brian Boswell, Dundee (GB); Richard Moynihan, Dundee (GB); Paul Sergeant, Dundee (GB)

Correspondence Address: RATNERPRESTIA, P O BOX 980, VALLEY FORGE, PA, 19482-0980, US

(21) Appl. No.: 10/573,121

(22) PCT Filed: Sep. 22, 2004
(86) PCT No.: PCT/GB04/04051

§ 371 Date: Jan. 5, 2007

(30) Foreign Application Priority Data
Sep. 23, 2003 (GB) 0322191.8

(51) Int. Cl. G06F 9/46; G06F 9/44

(52) U.S. Cl. 719/321

(57) ABSTRACT

A computer having a software agent for representing a person in the virtual environment. The software agent has one or more application specific modules each of which represents application specific features of the agent. In addition, the agent has a core module which contains one or more functional groups which define common or generic features of the agent which assist in facilitating inter-agent communication, such that inter-agent communication supports communication between a combination of the one or more application specific module and the core module, to provide improved messaging between agents and between agents and users.

The present invention relates to the use of agents to provide persistent, tailored presence in the electronic world for a given user of a (suite of) mobile device(s), in particular, a modular architecture of the agent and messaging methods within and between agents.

A user has multiple presences in the electronic world, including:
the transient, anonymous presence of an online search;
persistent occasional presence of online shopping at a particular store;
persistent passive presence of directed marking;
persistent though temporary realtime presence in an online game;

and many more. It would be advantageous to bring these many applications and domains together, and provide the user with a single, tailored interface to the electronic world.

As users interact with the electronic world increasingly frequently to serve an ever-greater set of goals, they encounter three problems. First, the volume of information can make it extremely difficult to identify relevant sources: this is the well-known information overload problem. Secondly, interacting with numerous services (information provision, e-shopping, electronic auction houses, alerting services, etc.) means that users have to remember how to use a wide variety of different interfaces, each with their own idiosyncrasies, required data, stored data, and so on. Many web sites will remember little or no information about given customers other than their order history. This is the interface problem. Finally, there is no structured way for these services to interact. Booking a holiday for example, would require visits to numerous web sites (information provision, flight booking, hotel booking, newsgroup archives, etc.) and often—indeed, usually—it is simpler just to call a human travel agent. This is the interaction problem. There are existing attempts to solve each of these problems separately. These attempts have had varying degrees of success and are at varying levels of maturity: some web browsers, for example have built-in components to try to tackle information overload though for the most part these are not terribly effective; similarly, web services offer a potential means of integrating different services, but their deployment has been limited to date, and it is not clear that there is sufficient market pressure to further encourage providers to provide web service based interaction.

Agentive representation offers a coherent means of dealing with all three problems. Agents can act as bidirectional filters of information, limiting information presented to a user based on an internal user model, and limiting information about the user that is provided to electronic services based on internal rules developed in conjunction with the user. This is a means of tackling the information overload problem. Agents can maintain information about dealing with other online services, automating the process of form-filling, button-clicking, and interaction with specific Web Services. This offers a means of tackling the interface problem. Finally, agents can act autonomously to collate information and services in order to meet goals specified by the user or adopted independently by the agent. This offers a means of dealing with the interaction problem.

The idea of employing agents to represent users has been widely deployed in systems in a variety of domains. Typically, these systems are locked in to their respective domains (such as e-commerce, stock trading information, etc.), and do not try to cater for multiple domains. They are also not fundamentally based on the mobility of users (though some may have simple mobile capabilities, such as SMS alerting). Indeed these two restrictions—single domain and non-mobile—are related. It would be advantageous to focus on the user, wherever they may be, and whatever they may be doing, rather than viewing a user as simply that part of a human that is interacting with a particular computer system.

International Patent Application Number WO0157724 discloses having an agent represent a user that connects via a mobile device. It fails at overcoming the above-identified problems in two main respects. First, all functionality is hardcoded, with no capacity for concurrent and dynamic activity in multiple domains. Second, the user connects to his or her agent via one particular communication channel. It would be advantageous for connection to be achieved through any number of channels, mobile or wired, with media provided by the agent for the user tailored to the device currently in use.

It is an object of the present invention to provide improved calling of methods within an agent.

It is a further object of the present invention to provide improved messaging between agents and between agents and users.

In accordance with a first aspect of the present invention there is provided computing means having a software agent for representing a person in the virtual environment, the software agent comprising: one or more application specific modules each of which represents application specific features of the agent; a core module which contains one or more functional groups which define common or generic features of the agent, said features at least in part facilitating inter-agent communication, such that inter-agent communication supports communication between a combination of the one or more application specific module and the core module.

Preferably, the functionality of the functional group comprises one or more of the following, belief management, user profile management, agent-user communication, module management, basic generic reasoning tools and/or between agent module to module communication.

Preferably, the core module is provided with method means which provide the one or more functional groups.

Preferably, the functionality of the functional group correspond to a set of labels.

Preferably, communication means are provided to facilitate communication between application specific modules in different agents.

Preferably, the core module acts as an interface between external devices and the at least one application specific module.

Preferably, specification of message conversation protocols and the specification of primitive message semantics are implemented in separate modules.

Preferably, the core module provides primitive semantics for defining communication.

Preferably, the application specific module(s) specify message conversation protocols.

Preferably, the software agent is further provided with an inter-module communications means.

Preferably, said inter-module communications means connects together all application specific modules and the core module in the agent.

Preferably, the inter-module communication means is provided with one or more function calls.

Preferably, the inter-module communication means provides for communication between functions in different modules of an agent.

Preferably, the inter-module communication means provides for mapping a request from a first module to a method means in a second module.

Preferably, said request from said first module comprises a label specifying a function and said method means in a second module corresponds to the specified function.

Preferably, the agent further comprises an address resolving means for resolving an address in a message to one of said plurality of modules.

Preferably said agent further comprises a transfer means for transferring messages from said resolved modules such that the messages are interleaved to allow an agent to be simultaneously involved in multiple conversations with other agents.

Preferably, the computing means is one or more computer.

Optionally, the computing means is one or more personal digital assistant.

Optionally, the computing means is one or more mobile communications device.

Optionally, the computing means is distributed across a plurality of computing devices.

According to a second aspect of the invention there is provided a method of performing functions in the software agent in accordance with the first aspect of the invention, the method comprising the steps of:
receiving a request specifying a function;
mapping said request to a module method corresponding to the specified function; and
invoking said module method.

Preferably said request comprises a label specifying said function.

Preferably the step of invoking said module comprises the steps of:
receiving a request comprising a label;
looking up the label in a table; and
calling a method corresponding to the label.

Preferably the step of invoking said module further comprises the step of selecting a highest priority method corresponding to the label.

Optionally, the method of invoking said module further comprises the step of returning a value to the originator of the request.

According to a third aspect of the present invention, there is provided a method of inter-agent communication between agents as defined in the first aspect of the invention, the method comprising the steps of:
receiving a message comprising at least in part an address from a first agent;
a resolving said address to one of a plurality of modules in a second, receiving agent; and
transferring the message to the resolved module.

Preferably said address specifies the module.

The method comprises the steps of communicating with an external device by:
identifying the device that a user is employing;
mapping said device to a set of media types; and
initiating the delivery of media to said device responsive to the mapped set.

Optionally the method further includes the step of limiting the set of media types based on user preferences.

According to a fourth aspect of the present invention there is provided a computer program comprising program instructions for causing a computer to operate a software agent as defined in the first aspect of the invention.

According to a fifth aspect of the present invention there is provided a computer program comprising program instructions for causing a computer to perform the method as defined in the second aspect of the invention.

According to a fifth aspect of the present invention there is provided a computer program comprising program instructions for causing a computer to perform the method as defined in the second aspect of the invention.

In order to provide a better understanding of the present invention, an embodiment will now be described by way of example only and with reference to the accompanying Figures, in which:

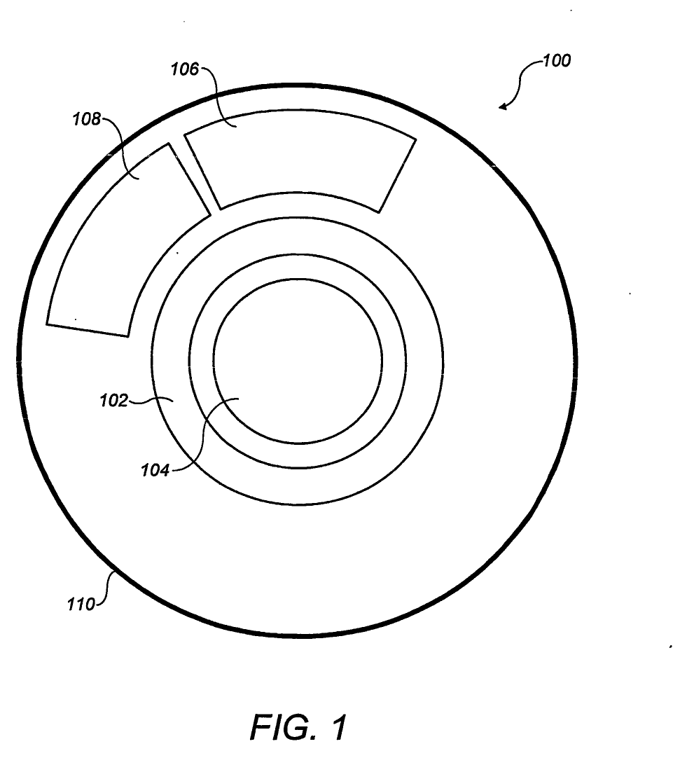

FIG. 1 illustrates, in schematic form, an agent in accordance with a preferred embodiment of the present invention;

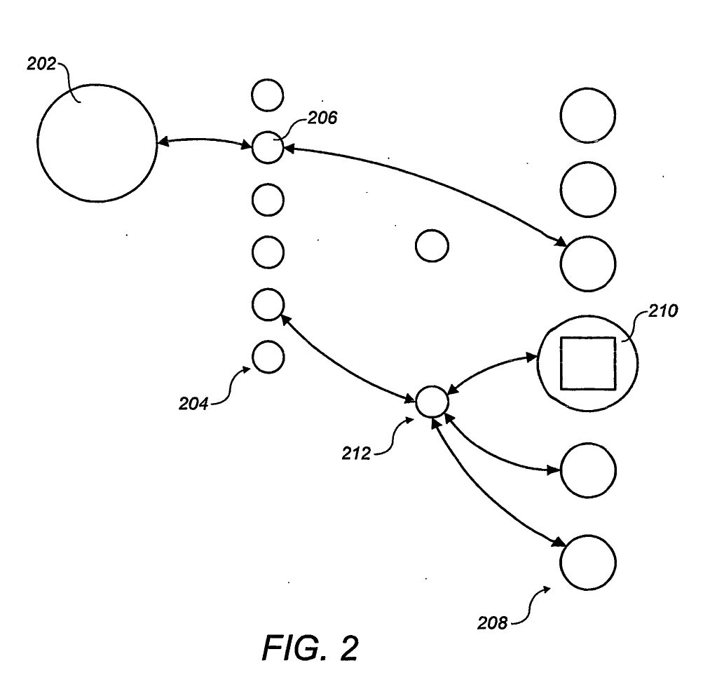

FIG. 2 illustrates, in schematic form, an overview of agentive representation in a multi-service environment;

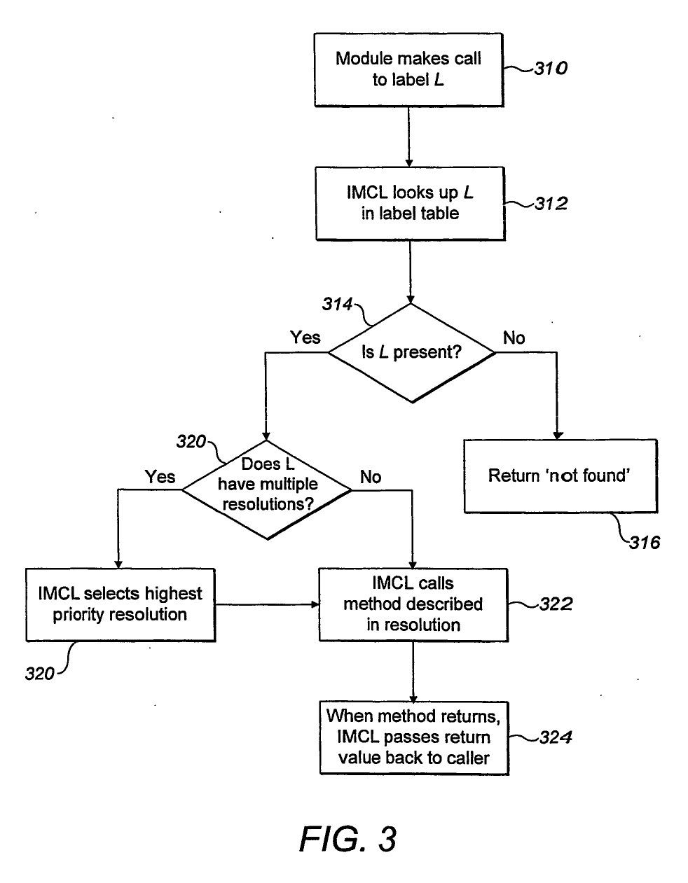

FIG. 3 illustrates, in schematic form, the process by which a label is resolved in accordance with a preferred embodiment of the present invention;

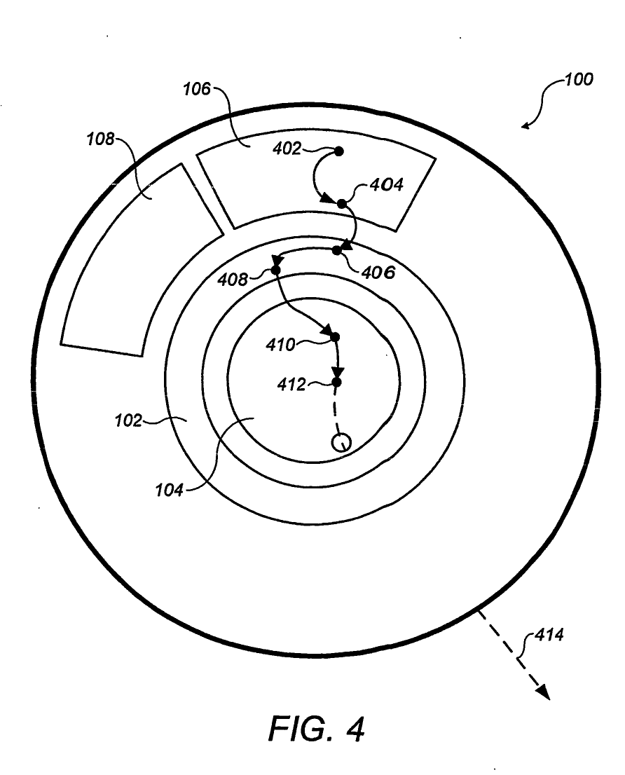

FIG. 4 illustrates, in schematic form, the process of a module sending messages in accordance with the present invention;

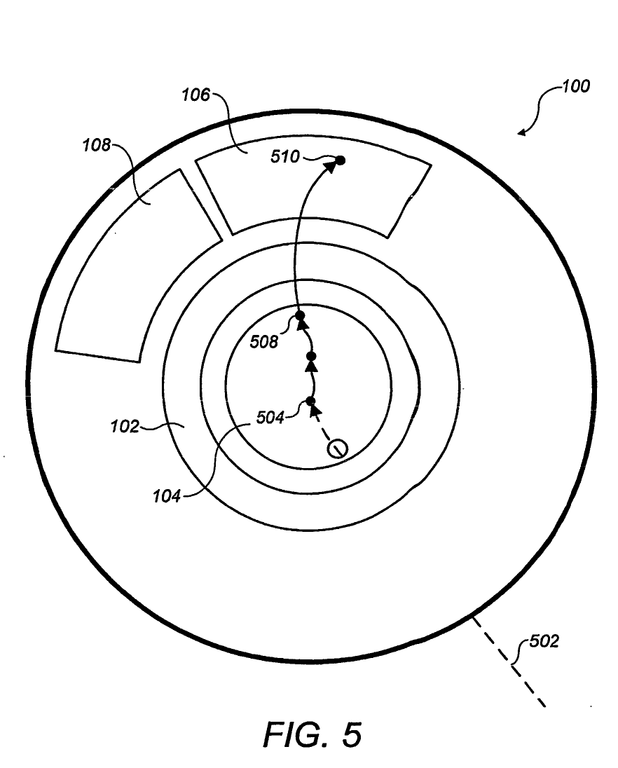

FIG. 5 illustrates, in schematic form, the process of a module receiving messages in accordance with the present invention;

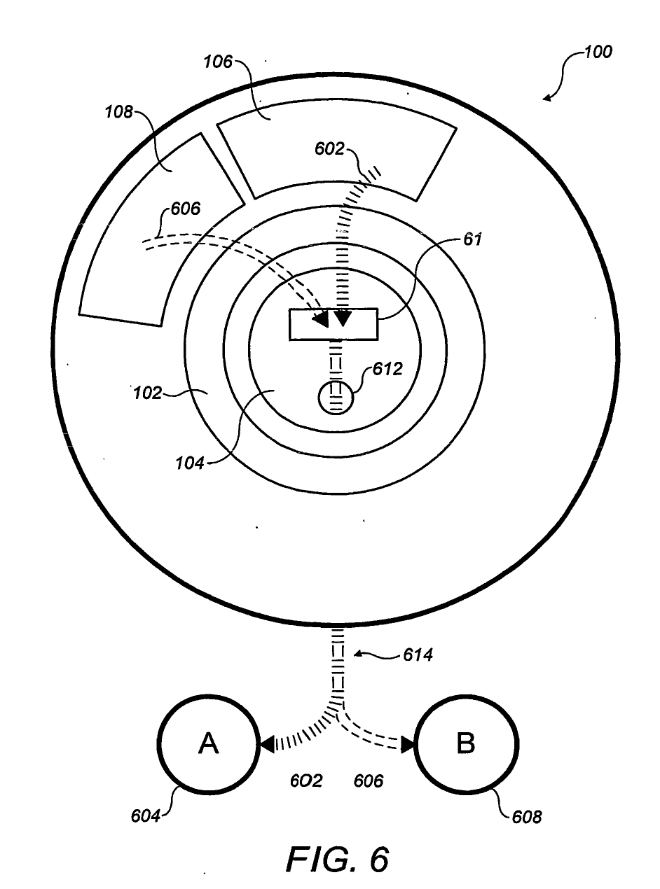

FIG. 6 illustrates, in schematic form, conversation interleaving in accordance with the present invention;

The inventions relate to an agent architecture and methods for communication between modules in the agent, with other agents in a multi-agent environment and with users.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code of intermediate source and object code such as in partially compiled form suitable for use in the implementation of the processes according to the invention. The carrier may be any entity or device capable of carrying the program.

For example, the carrier may comprise a storage medium, such as ROM, for example a CD ROM or a semiconductor ROM, or a magnetic recording medium, for example, floppy disc or hard disc. Further, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

With reference to FIG. 1, the architecture 100 of an agent according to the present invention is best visualised as including a torus. On the inside of the torus 102, a special module, the core module 104, attaches itself. On the outside of the torus, any number of application specific modules 106, 108 may also become attached. The security and unity of the agent is also conceptually protected by a thin sphere 110 encompassing all the modules. The torus itself coordinates all communication between modules and between modules and core: this is the Inter Module Communication Layer (IMCL).

A user interacts with the electronic world for a host of reasons in a wide variety of domains: entertainment, e-commerce, professional, and so on. The present invention provides a means of bringing together all of these tasks and domains, and providing a single point of contact for the user, and allowing the sharing of user data between these different application domains. This contact is the user's agent, both in the computer-science sense (where agent oriented programming has particular restrictions, techniques and approaches, and places particular demands on software), and also in the intuitive sense of providing services of advocacy and representation. A user's agent is their permanent representative in the electronic world. Ideally, each user has exactly one agent, and a user's agent represents exactly one user (at the very least, such a relationship exists in a given context). The overall picture is as in FIG. 2.

With reference to FIG. 2, an overview of agentive representation in a multiservice environment is shown. The user 202 connects to their agent 206 at any time via any device (2G phones, multimedia mobile handsets, internet, etc.) in ways that are well known. The user agents 204 which represent users in the virtual world are shown. One user has a single agent 206 representing him or her in all their interactions in the virtual world. The service agents 208 provide specific services to any agents that request them, or that the service agents themselves decide to service. Information exchange between user and service agents can be initiated from either end. Some service agents 210 encapsulate existing legacy services (e.g., databases, Web Services and proprietary data handling systems). Broker agents 212 can mediate between a user and service agents. The user agents service agents and broker agents may be provided as a trusted service by a telecommunications operator.

An agent is a software entity with particular characteristics. We refer here to software processes that are:
(i) persistent (in that they continue to exist for an extended real time period, adapting to a single user over that time);
(ii) proactive (in that they include not only reactive behaviour, but also independently determined behaviour);
(iii) communicative (in that they communicate with other agents); and
(iv) autonomous (in that they typically cannot be directly modified by outside agencies, but must instead be altered through communciation).

The user can communicate with his agent across heterogeneous networks from a variety of devices, including mobile handsets and internet clients. In addition, however, the framework of the present invention supports the transparent filtering of information according to the device to which it is being sent. Thus the components within an agent that initiate communication with a user need not have any representation of the device type a user is employing. The content of the message is instead dynamically tailored to the user's device (e.g. summary text to an SMS-enabled mobile device, still pictures to a MMS-enabled mobile device, streaming video to broadband internet client platform, etc.).

The core is responsible for tailoring information to the device that is known to currently be available to the user. Thus, tailoring happens independently of the module calls, so that individual modules do not need to maintain device-specific information.

This filtering is achieved through a module-independent communication object that is filled in by individual modules when they need to communicate with the user. This object has subparts for different forms of media (text, picture, video, audio, etc). A module fills in as many of these subparts as it is able. The core then mediates the sending of that message to the user, by:
(i) identifying which device the user is currently employing (using a combination of historical usage patterns, presence information, and most recent-communication data);
(ii) mapping the device to a set of media types (so, e.g., an old phone can handle text, a newer device, pictures);
(iii) further limiting the media types on the basis of user preferences, and what has been made available by the module; and
(iv) initiating the delivery of the appropriate media from the user communication object constructed by the module.

In order to provide representation for a user, an agent must implement a range of functionality. This functionality is gathered together into the core module. Modules can safely make the assumption that the core is available for them to make calls upon.

The core contains a range of specific methods that implement particular components of functionality. These methods can be grouped together into functional groups. Thus the core can be subdivided into discrete areas of functionality. Any module can make a call on any of the methods in any of the areas of the core's functionality via the IMCL. The core provides methods that provide functionality corresponding to a fixed set of labels concerned with generic agent activity. This functionality includes:
1. Belief management (including lookup and update)
2. User profile management (including lookup and update)
3. Agent-User communication
4. Module Management
5. Basic generic reasoning tools
6. Between-Agent Module-Module communication (BAMM) (send and receive)

The agent as a whole is a unitary autonomous software entity, and as such maintains a single, coherent set of token expressions representing information about the world. The language from which these beliefs are constructed is given by domain-specific ontologies provided centrally. Beliefs are stored in a single database using existing technology.

The belief database is changed through the action of methods in the core. These methods implement core labels for belief update. Any module (including the core itself) can make calls as described herein on these labels through the IMCL.

Similarly, the belief database can be queried by any method through a call to a label mapped through the IMCL to core functionality. Thus a module can initiate update or lookup on the currently held beliefs by calling this label.

The user profile is a subset of the belief database, and includes information specific to the user across a range of domains. Again, the core implements labels corresponding to update and query to the user profile.

There is the potential for the core to update the user profile dynamically in response to user actions—that is, the agent could adapt to and learn the user's preferences as a result of repeated interaction.

User data (e.g., address; credit card details; age) and user preferences (e.g., policy on releasing credit card details; preference for aisle or window seat on planes; preferred DVD supplier) are stored in a local, private, secure database. Both user data and user preferences are extracted in three ways. First, through an explicit online interface that requests input on date of birth, or supports update to reflect change of address. Second, if the agent recognises information that it needs from the user, it can ask for it directly (e.g. asking a yes/no question by SMS). Third, as the user interacts with services manually, the agent can intercept information either explicitly or implicitly. If the user answers a particular question from a particular online service, the agent may either store that answer for future use, or ask the user explicitly if such storage is appropriate or useful. When acting autonomously, the agent provides only the information that external service requires (and no more), less anything that the user has placed a restriction on. Thus, for example, when interacting with an online newspaper, the newspaper provider may request user registration, but not demand it. In this case, the agent would provide no user information. Alternatively, when interacting with a book e-tailer, the e-tailer may require personal details including credit card data. If the user has instructed his or her agent not to give out credit card details without confirming it first, the agent would halt interaction with that site until user confirmation was sought and agreed.

These components could be represented by the steps:
1. Agent has goal of interacting with a service
2. Select required information from the user model (UM) (accesses the UM)
3. Check that the user model permits all this information to be freely given (accesses the UM)
If so,
4. Information given to the service
Otherwise
5. Process the restriction (either by terminating, or by asking the user, or by performing some other action)

The core also includes a subsystem responsible for passing messages to, and receiving messages from the user. The user may connect to his or her agent through a number of different channels: using a web browser on a PC, using a rich media mobile device (a Java phone, for example), using a high capacity mobile device (such as one that uses GPRS), or using an older, limited media device (say that can only handle voice and SMS traffic). The core implements labels that handle communication to and from such devices quite transparently: the calling module need not specify different communication types.

The means by which one agent communicates with another is implemented in the core. Rather than supporting only agent-to-agent messages, the architecture is instead built around the idea that it is individual modules within agents that communicate with one another (this is “between agent module-module” or BAMM communication). Thus a module with expertise in buying in a particular e-commerce institution will communicate with a module in another agent that has expertise in selling in that same e-commerce institution. The fact that those agents also happen to have modules with expertise in a range of other diverse applications has no impact upon the conversation between buyer and seller in this domain. It is thus modules that structure conversations. The individual utterances (or, more accurately, utterance types) that a module uses to construct a given conversation are common across the entire architecture. The sending and receiving of these individual utterances is co-ordinated by the core.

In this way, a module in an agent can conduct conversations tailored to the domain in which the module has competence. Though the conversation structure is tailored, the implementation of primitive sending and receiving is located in the core. This means that there needs to be only one language definition—the language that agents use for all communication. (If BAMM communication was implemented solely in modules, those modules would, by definition, use their own idiosyncratic languages, and therefore the number of languages would be proportional to the square of the number of module types.) As language design and verification is a labour intensive task, reducing the task by separating primitive semantics from conversation definition, and rendering the former once only in the core, saves a great deal of effort.

The IMCL provides a small number of function calls, the most important of which is the call which effects Within-Agent Module-Module (WAMM) communication. When one module wants to call a method in another module (including a method provided by the core) it calls the IMCL's WAMM communication method, passing it a label. The IMCL then resolves that label by referring to its table of labels.

This means that one module need not know which other module implements the functionality of a given label. Indeed, a module can be implemented in such a way that it can attempt a call on some labelled functionality, but exhibits robustness in the event that no module is present that implements that functionality. (Consider, for example, module x that is, amongst other things, responsible for performing some exponentiation calculation. Module x has two ways of performing the calculation—doing it itself, slowly and laboriously using repeated addition, or by asking a specialised module y that can do exponentiation quickly and efficiently. The problem is that x has no way of knowing whether or not y is installed. Thus x makes a call to the IMCL requesting exponentiation on a particular data set. If y is installed, the IMCL will pass the request to the appropriate method within y. If y is not installed, the IMCL will inform x that no module implements exponentiation and x can then follow the more laborious route of performing the calculation itself). The process by which a label is resolved is summarised in FIG. 3.

With reference to FIG. 3, a module makes a call to label L 310. The IMCL looks up L in a label table 312. If L is not present 314, the IMCL returns “not found” 316. If L is present, and L does have multiple resolutions 318, then the IMCL selects the highest priority resolution 320. Next the IMCL calls the method described in the resolution 322. Finally, when the method returns a value 324, the IMCL passes the return value back to the caller.

A practical advantage of the approach is that it removes compile time dependencies: a module developer can design, implement and test a module which makes calls to another module that they do not have, or do not have access to, or, indeed, that has not been developed at all. This simplifies many of the problems of software engineering in the large, and of multi-site collaborative development work.

For sending messages, the core implements a unique label that sends a preconstructed message that conforms to the structure of the system's ACL through the transport layer to the recipient agent. The series of steps by which this is achieved is shown in FIG. 4.

With reference to FIG. 4, the components of the agent 102, 104, 106 and 110 are as described in FIG. 1. First the module builds an ACL message with module@agent recipient and content 402. The module calls the IMCL with a specific label (such as “talk2agent”) and the ACL message 404. IMCL resolves talk2agent label call to a specific core method (such as “TalkToAgent”) 406. The IMCL calls core's TalkToAgent method with the ACL message 408. core.TalkToAgent resolves agent name to transport specific identifier 410. Transport calls are made to deliver the message 412. Finally the message is transported 414.

With reference to FIG. 5, components of the agent 102, 104, 106 and 110 are as described in FIG. 1. The incoming message 502 corresponding to the outgoing message 414 of FIG. 4 is transported into the agent. The message arrives in the core from the transport layer 504. The core makes a call 508 to the module's message handler 510, from where the module processes the message. For the receipt of ACL messages, the core implements a queue mechanism. Individual messages should be addressed to “module@agent”, thus specifying not only the agent to which the message is addressed, but also the specific module within that agent. (Messages that are underspecified and do not indicate a recipient module are handled separately by the core). The core queues these messages, and passes them to individual modules according to the message address, when appropriate reprocessing resources become available.

In line with a number of other frameworks, the semantics of ACL utterances are defined in terms of preconditions and postconditions—that is, things that must be true before a message can be sent, and things that must be true after a message has been received (for example, inform-ing an agent may require that the fact being informed is initially believed by the informing agent—this is sincerity).

The core is responsible for implementing the ACL semantics. The message sending functionality filters messages, only sending those that meet the semantic constraints (such as sincerity). The message receiving functionality similarly implements the postcondition semantics by updating the belief database before the message is placed on the queue for handling by the recipient module.

The combination of queuing mechanisms for messages, explicit module addressing, and a common, core-implemented semantics for primitives, provides for a technique that may be called ‘conversation interleaving’.

Conversation interleaving refers to the way in which a single agent can simultaneously be involved in multiple conversations with other agents, with individual modules responsible for the maintenance of a given conversation, even though the primitives from which conversations are composed are sent and received through the agent's single interface with the rest of the agent world.

By analogy, imagine yourself on the phone trying, say, to arrange car insurance—every so often, the person you are speaking to comes back to you, has a brief exchange and then puts you back on hold while they try and find another quote. Simultaneously you could be having a chat with an office colleague. The ‘car insurance’ part of you is holding a conversation on the phone, and the ‘office smalltalk’ part with someone in front of you—two simultaneous conversations even though you can only say one thing to one person at a time. An example of conversation interleaving is illustrated in FIG. 6.

With reference to FIG. 6, the agent 100 contains the same components 102, 104, 106 and 108 as described in FIG. 1. The first module 106 send messages 602 destined for agent A 604 to the core 104. The second module 108 send messages 606 destined for agent B 608 to the core. The core functionality 610 marshals outgoing messages and the messages are sent 612 to the transport layer for delivery (as in FIG. 4). Therefore the messages 602 and 606 are interleaved 614 and messages from the first module are delivered to agent A and messages from the second module are delivered to agent B.

1. Computing means having a software agent for representing a person in the virtual environment, the software agent comprising:
one or more application specific modules each of which represents application specific features of the agent;
a core module which contains one or more functional groups which define common or generic features of the agent, said features at least in part facilitating inter-agent communication, such that inter-agent communication supports communication between a combination of the one or more application specific module and the core module.

2. Computing means as claimed in claim 1 wherein, the functionality of the functional group comprises one or more of the following, belief management, user profile management, agent-user communication, module management, basic generic reasoning tools and/or between agent module to module communication.

3. Computing means as claimed in claim 1 wherein, the core module is provided with method means which provide the one or more functional groups.

4. Computing means as claimed in claim 1 wherein, the functionality of the functional group correspond to a set of labels.

5. Computing means as claimed in claim 1 wherein, communication means are provided to facilitate communication between application specific modules in different agents.

6. Computing means as claimed in claim 1 wherein, the core module acts as an interface between external devices and at least one application specific module.

7. Computing means as claimed in claim 1 wherein a specification of message conversation protocols and a specification of primitive message semantics are implemented in separate modules.

8. Computing means as claimed in claim 7 wherein, the core module provides primitive semantics for defining communication.

9. Computing means as claimed in claim 1 wherein, the one or more application specific modules specify message conversation protocols.

10. Computing means as claimed in claim 1 wherein, the software agent is further provided with an inter-module communications means.

11. Computing means as claimed in claim 10 wherein, said inter-module communications means connects together all application specific modules and the core module in the agent.

12. Computing means as claimed in claim 10 wherein, the inter-module communication means is provided with one or more function calls.

13. Computing means as claimed in claim 10 wherein, the inter-module communication means provides for communication between functions in different modules of an agent.

14. Computing means as claimed in claim 10 wherein, the inter-module communication means provides for mapping a request from a first module to a method means in a second module.

15. Computing means as claimed in claim 14 wherein, said request from said first module comprises a label specifying a function and said method means in a second module corresponds to the specified function.

16. Computing means as claimed in claim 1 wherein, the agent further comprises an address resolving means for resolving an address in a message to one of said plurality of modules.

17. Computing means as claimed in claim 1 wherein said agent further comprises a transfer means for transferring messages from said resolved modules such that the messages are interleaved to allow an agent to be simultaneously involved in multiple conversations with other agents.

18. Computing means as claimed in claim 1 wherein, the computing means is one or more computers.

19. Computing means as claimed in claim 1 wherein, the computing means is one or more personal digital assistants.

20. Computing means as claimed in claim 1 wherein, the computing means is one or more mobile communications devices.

21. Computing means as claimed in claim 1 wherein, the computing means is distributed across a plurality of computing devices.

22. A method of performing functions in the software agent of the computing means defined in claim 1, the method comprising the steps of:
receiving a request specifying a function;
mapping said request to a module method corresponding to the specified function; and
invoking said module method.

23. The method of claim 22 wherein, said request comprises a label specifying said function.

24. The method of claim 23 wherein, the step of invoking said module comprises the steps of:
receiving a request comprising a label;
looking up the label in a table; and
calling a method corresponding to the label.

25. The method of claim 24 wherein the step of invoking said module further comprises the step of selecting a highest priority method corresponding to the label.

26. The method of claim 24 wherein, the method of invoking said module further comprises the step of returning a value to an originator of the request.

27. A method of inter-agent communication between software agents of the computing means defined in claim 1, the method comprising the steps of:
receiving a message comprising an address from a first agent;
resolving said address to one of a plurality of modules in a second, receiving agent; and
transferring the message to the resolved module.

28. The method of claim 27 wherein said address specifies the module.

29. The method of claim 27 wherein, the method further comprises the steps of communicating with an external device by:
identifying the device that a user is employing;
mapping said device to a set of media types; and
initiating the delivery of media to said device responsive to the mapped set.

30. The method of claim 29 wherein, the method further includes the step of limiting the set of media types based on user preferences.

31. A computer program comprising program instructions for causing a computer to operate a software agent as claimed in claim 1.

32. A computer program comprising program instructions for causing a computer to perform the method of claim 22.

33. A computer program comprising program instructions for causing a computer to perform the method of claim 27.
